(19) United States
(12) Patent Application Publication
(10) Pub. No.: US 2009/0104455 A1
(43) Pub. Date: Apr. 23, 2009

(54) TRANSPARENT CONDUCTIVE COMPONENT UTILIZED IN TOUCH PANEL

(76) Inventors: Miin-Jang Chen, Taipei City (TW); Wen-Ching Hsu, Hsinchu City (TW); Szu-Hua Ho, Jhudong Township (TW)

Correspondence Address: Muncy, Geissler, Olds & Lowe, PLLC, P.O. BOX 1364, FAIRFAX, VA, 22038-1364, US

(21) Appl. No.: 12/255,915

(22) Filed: Oct. 22, 2008

(30) Foreign Application Priority Data
Oct. 23, 2007 (TW) 096139598

(51) Int. Cl. B32B 17/06; B32B 18/00

(52) U.S. Cl. 428/432; 428/702; 428/412; 428/480; 428/419; 428/473.5; 428/522

(57) ABSTRACT

The invention discloses a transparent conductive component utilized in a touch panel. The transparent conductive component according to the invention includes a transparent substrate and a ZnO film. The transparent substrate has an upper surface. The ZnO film is formed by an atomic layer deposition process and/or a plasma-enhanced (or a plasma-assisted) atomic layer deposition process on the upper surface of the transparent substrate.

### BACKGROUND OF THE INVENTION

1. Field of the Invention

The present invention relates to a transparent conductive component, and more particularly, to a transparent conductive component utilized in a touch panel.

2. Description of the Prior Art

With the rapid growth of information and electronic products, touch panels have been employed extensively and start becoming an independent industry in the world. With the advanced input function, touch panels are equipments providing the simplest, convenient, and natural way for searches on multimedia information. The touch panels have advantages such as a good stability, a quick response, space-saving, and an easy interaction.

For example, the touch panel technique have been applied to portable smart phones and MP3 players, to car-use global positioning systems (GPS) and entertaining systems, to public-use ATMs and multimedia information service stations, e.g. Kiosk, and to the newest ultra-mobile PCs and notebooks, etc. After associated applications are issued, the touch panels will affect human lives widely.

Especially, after iPhone is issued, developments of mobile phones with multimedia functions and large screens have become a trend, thus touch panels have more and more applications. Because the needs for the market increase largely, supplies of the touch panels gradually fall short of demands. The main reason is that the commercially available ITO films or ITO glasses are deficient in production Furthermore, the In element contained in ITO is a rare element, and if the consumption of the In element keeps increasing, the fabrication cost will be increased greatly for the reason of a limited supply of the In element. Therefore, how to get stable resources for the ITO films or ITO glasses has been an essential issue to be resolved for all manufacturers. Additionally, developing a new transparent conductive material to replace ITO can be regarded as a positive proposal.

On the other hand, after the Microsoft issued the novel flat-panel computer “Surface”, large-scale touch panels are expected to have considerable markets in the future. In the prior art, the ITO films or ITO glasses are usually prepared by sputtering. However, for the computer like “Surface” which needs a large-scale touch panel, the traditional sputtering process has not reached a favored manufacturing efficiency yet. As a result, in response to the large-scale touch panel, how to develop a cost-effective and efficiency-oriented manufacturing process is certainly a significant issue.

Accordingly, the main scope of the invention is to provide a transparent conductive component utilized in a touch panel to solve the above problems.

### SUMMARY OF THE INVENTION

One scope of the invention is to provide a transparent conductive component utilized in a touch panel.

According to an embodiment of the invention, the transparent conductive component includes a transparent substrate and a first ZnO film. The transparent substrate has an upper surface. The first ZnO film is formed by an atomic layer deposition process and/or a plasma-enhanced (or a plasma-assisted) atomic layer deposition process on the upper surface of the transparent substrate.

Compared to the prior art, since the transparent conductive component according to the invention utilizes the ZnO film as the transparent conductive layer, the shortage of the ITO materials which the traditional touch panel will face can be solved. Additionally, because the transparent conductive component according to the invention has the merits of large-area uniformity, mass production, and low cost, it is quite beneficial to practical applications.

The advantage and spirit of the invention may be understood by the following recitations together with the appended drawings.

### BRIEF DESCRIPTION OF THE APPENDED DRAWINGS

FIG. 1A illustrates a sectional view of the transparent conductive component utilized in a touch panel according to an embodiment of the invention.

FIG. 1B illustrates a sectional view of the transparent conductive component utilized in a resistive-type touch panel.

FIG. 2 illustrates a sectional view of the transparent conductive component utilized in a touch panel according to another embodiment of the invention.

### DETAILED DESCRIPTION OF THE INVENTION

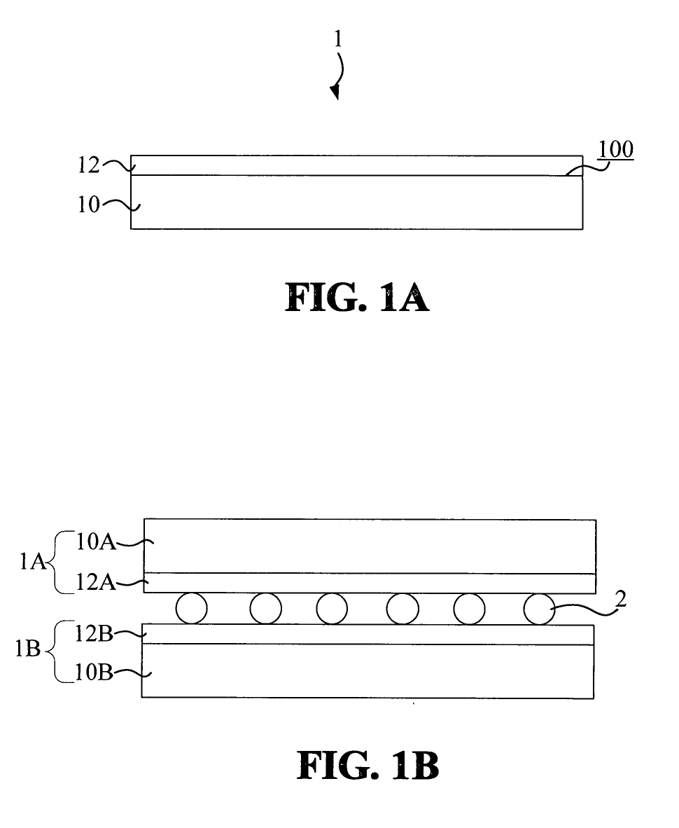

Please refer to FIG. 1A. FIG. 1A illustrates a sectional view of the transparent conductive component 1 utilized in a touch panel according to an embodiment of the invention.

As shown in FIG. 1A, the transparent conductive component 1 includes a transparent substrate 10 and a first ZnO film 12. The transparent substrate 10 has an upper surface 100. The first ZnO film 12 is formed on the upper surface 100 of the transparent substrate 10.

In this embodiment, the first ZnO film 12 can be formed by an atomic layer deposition process and/or a plasma-enhanced (or a plasma-assisted) atomic layer deposition process.

The transparent substrate 10 can be made of polyethylene terephthalate (PET), polyethersulfone (PES), polycarbonate (PC), acrylic, polymide or glass, but not limited therein.

In recent years, large amount of the ITO materials are used in the semiconductor optoelectronic devices (e.g. light-emitting diodes) and the currently popular touch panels. The In element contained in ITO is a rare element, and if the consumption of the In element keeps increasing, the fabrication cost of the aforesaid devices will be increased greatly for the reason of a limited supply of the In element, thus a substitute material for ITO is inevitable. Currently, ZnO is regarded as the most potential substitute since the conductivity and transparency of ZnO are similar to those of ITO. Besides, compared to ITO, ZnO is commercially more attractive because it is cheap and abundant.

The precursors of the first ZnO film 12 can be ZnCl₂, ZnMe₂, ZnEt₂, H₂O, O₃, O₂ plasma and oxygen radicals, where the Zn element comes from ZnCl₂, ZnMe₂ or ZnEt₂; the O element comes from H₂O, O₃, O₂ plasma or oxygen radicals.

Taking the deposition of the first ZnO film 12 as an example, an atomic layer deposition cycle includes four reaction steps of:

1. Using a carrier gas to carry H₂O molecules into the reaction chamber, thereby the H₂O molecules are absorbed on the upper surface of the substrate to form a layer of OH radicals, where the exposure period is 0.1 second;

2. Using a carrier gas to purge the H₂O molecules not absorbed on the upper surface of the substrate, where the purge time is 5 seconds;

3. Using a carrier gas to carry ZnEt₂ molecules into the reaction chamber, thereby the ZnEt₂ molecules react with the OH radicals absorbed on the upper surface of the substrate to form one monolayer of ZnO, wherein a by-product is organic molecules, where the exposure period is 0.1 second; and

4. Using a carrier gas to purge the residual ZnEt₂ molecules and the by-product due to the reaction where the purge time is 5 seconds.

The carrier gas can be highly-pure argon or nitrogen. The above four steps, called one cycle of the atomic layer deposition, grows a thin film with single-atomic-layer thickness on the whole area of the substrate. The property is called self-limiting capable of controlling the film thickness with a precision of one atomic layer in the atomic layer deposition. Thus, controlling the number of cycles of atomic layer deposition can precisely control the thickness of the ZnO film.

In conclusion, the atomic layer deposition process adopted by the invention has the following advantages: (1) able to control the formation of the material in nano-metric scale; (2) able to control the film thickness more precisely; (3) able to have large-area production; (4) having excellent uniformity; (5) having excellent conformality; (6) pinhole-free structure; (7) having low defect density; (8) having batch-type production; and (9) low deposition temperature, etc.

The first ZnO film 12 can be delta-doped, by the atomic layer deposition, during formation thereof with Al, Ga, In, Ti, Zr, Hf, Ta, La, Mg, or N, but not limited therein.

Taking the deposition of ZnO:Al, i.e. aluminum-doped zinc oxide (AZO), as an example, during the formation of ZnO film, partial ALD cycles of ZnEt₂ and H₂O can be replaced with the ALD cycles of Al(CH₃)₃ (i.e. trimethylaluminu, TMA) and H₂O, thereby Al is doped into the ZnO film and its concentration is determined by the ratio of the replaced ALD cycles.

For example, if the first ZnO film 12 can be doped with Al, Ga, In, Ti, or Zr, a transparent conductive film with a resistivity of 10⁻³˜10⁻⁴ Ω-cm can be obtained, which approaches the resistivity of ITO. In particular, if considering the lowest resistivity, the material resource and the toxicity together, the ZnO:Al transparent conductive film could become the most possible substitute for ITO in the foreseeable future. In one embodiment, the transparent conductive component 1 according to the invention can be utilized in a resistive-type touch panel. As shown in FIG. 1B, the transparent conductive component 1 according to the invention can be utilized in the upper transparent conductive component 1A and the lower transparent conductive component 1B of the resistive-type touch panel. The upper transparent conductive component 1A and the lower transparent conductive component 1B are separated by a spacer 2.

Similarly, the upper transparent conductive component 1A includes the transparent substrate 10A and the ZnO film 12A, and the lower transparent conductive component 1B includes the transparent substrate 10B and the ZnO film 12B. In practical applications, the transparent substrate 10B can be made of glass, and the transparent substrate 10A can be made of PET, but not limited therein.

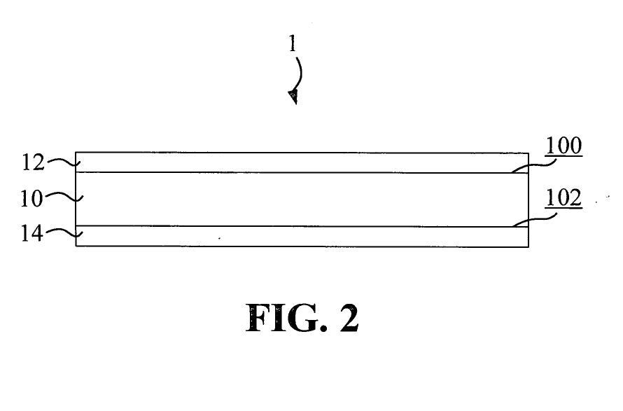

Please refer to FIG. 2. FIG. 2 illustrates a sectional view of the transparent conductive component 1 utilized in a touch panel according to another embodiment of the invention.

As shown in FIG. 2, the transparent substrate 10 can be formed of glass and has a lower surface 102. The transparent conductive component 1 further includes a second ZnO film 14 formed on the lower surface 102 of the transparent substrate 10.

The traditional capacitive-type touch panel includes a glass substrate, and each of the upper surface and the lower surface of the glass substrate is sputtered a layer of transparent conductive film, e.g. an ITO film. Therefore, in the embodiment, the transparent conductive component I can be utilized in a capacitive-type touch panel.

Similarly, the second ZnO film 14 can be formed by the atomic layer deposition process and/or the plasma-enhanced (or the plasma-assisted) atomic layer deposition process. The precursors of the second ZnO film 14 can be ZnCl₂, ZnMe₂, ZnEt₂, H₂O, O₃, O₂ plasma and oxygen radicals, where the Zn element comes from ZnCl₂, ZnMe₂ or ZnEt₂; the O element comes from H₂O, O₃, O₂ plasma or oxygen radicals.

Particularly, by adjusting the location of the transparent substrate 10 in the reaction chamber, e.g. to put the substrate vertically, the first ZnO film 12 and the second ZnO film 14 are deposited on the upper surface 100 and the lower surface 102 simultaneously to reduce the manufacturing time greatly.

Compared to the prior art, since the transparent conductive component according to the invention utilizes the ZnO film as the transparent conductive layer, the shortage of the ITO materials which the traditional touch panel will face can be solved. Additionally, because the transparent conductive component according to the invention has the merits of large-area uniformity, mass production, and low cost, it is quite beneficial to practical applications.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A transparent conductive component utilized in a touch panel, comprising:
a transparent substrate having an upper surface; and
a first ZnO film, formed by an atomic layer deposition process and/or a plasma-enhanced (or a plasma-assisted) atomic layer deposition process on the upper surface of the transparent substrate.

2. The transparent conductive component of claim 1, wherein the transparent substrate is made of one selected from the group consisting of a polyethylene terephthalate (PET), a polyethersulfone (PES), a polycarbonate (PC), an acrylic, a polymide and a glass.

3. The transparent conductive component of claim 2, wherein the precursors of the first ZnO film are ZnCl₂, ZnMe₂, ZnEt₂, H₂O, O₃, O₂ plasma and oxygen radicals, where the Zn element comes from ZnCl₂, ZnMe₂ or ZnEt₂; the O element comes from H₂O, O₃, O₂ plasma or oxygen radicals.

4. The transparent conductive component of claim 2, wherein the first ZnO film is delta-doped, by the atomic layer deposition, during formation thereof with one selected from the group consisting of Al, Ga, In, Ti, Zr, Hf, Ta, La, Mg, and N.

5. The transparent conductive component of claim 2, wherein the transparent substrate is formed of the glass and also has a lower surface, said transparent conductive component further comprises a second ZnO film formed on the lower surface of the transparent substrate.

6. The transparent conductive component of claim 5, wherein the second ZnO film is formed by the atomic layer deposition process and/or the plasma-enhanced (or the plasma-assisted) atomic layer deposition process.

7. The transparent conductive component of claim 6, wherein the precursors of the second ZnO film are ZnCl₂, ZnMe₂, ZnEt₂, H₂O, O₃, O₂ plasma and oxygen radicals, where the Zn element comes from ZnCl₂, ZnMe₂ or ZnEt₂; the O element comes from H₂O, O₃, O₂ plasma or oxygen radicals.

8. The transparent conductive component of claim 6, wherein the second ZnO film is delta-doped, by the atomic layer deposition during formation thereof with one selected from the group consisting of Al, Ga, In, Ti, Zr, Hf, Ta, La, Mg, and N.

9. The transparent conductive component of claim 6, wherein the first ZnO film and the second ZnO film are formed simultaneously.
